(19) United States
(12) Patent Application Publication
(10) Pub. No.: US 2013/0085683 A1
(43) Pub. Date: Apr. 4, 2013

(54) Preventive Activated Sludge Microlife Interpreter

(71) Applicants: Javier D'Carlo Garcia, Manhattan, KS (US); Travis William Smith, Manhattan, KS (US)

(72) Inventors: Javier D'Carlo Garcia, Manhattan, KS (US); Travis William Smith, Manhattan, KS (US)

(21) Appl. No.: 13/284,893

(22) Filed: Oct. 29, 2011

Related U.S. Application Data
(60) Provisional application No. 61/542,172, filed on Oct. 1, 2011.

(51) Int. Cl. G06F 19/00; G01N 31/00

(52) U.S. Cl. 702/25

(57) ABSTRACT

The invention is a portable laboratory instrument that incorporates software designed to record laboratory tests results to analyze the biomass of a Wastewater Treatment Plant (WWTP) using an Activated Sludge Process. The software uses the values entered by the user and its data bank/algorithms to determine the health/age of the biomass. It produces an interpretation of the collected data, and delivers a final set of instructions based on the overall health of the Wastewater Treatment Plant (WWTP). The final result is delivered using simple instructions and color coded lights for an easy and quick interpretation. Its use does not require extensive training in the field of wastewater treatment. Its purpose is to prevent environmental disasters by detecting current/future biological problems.

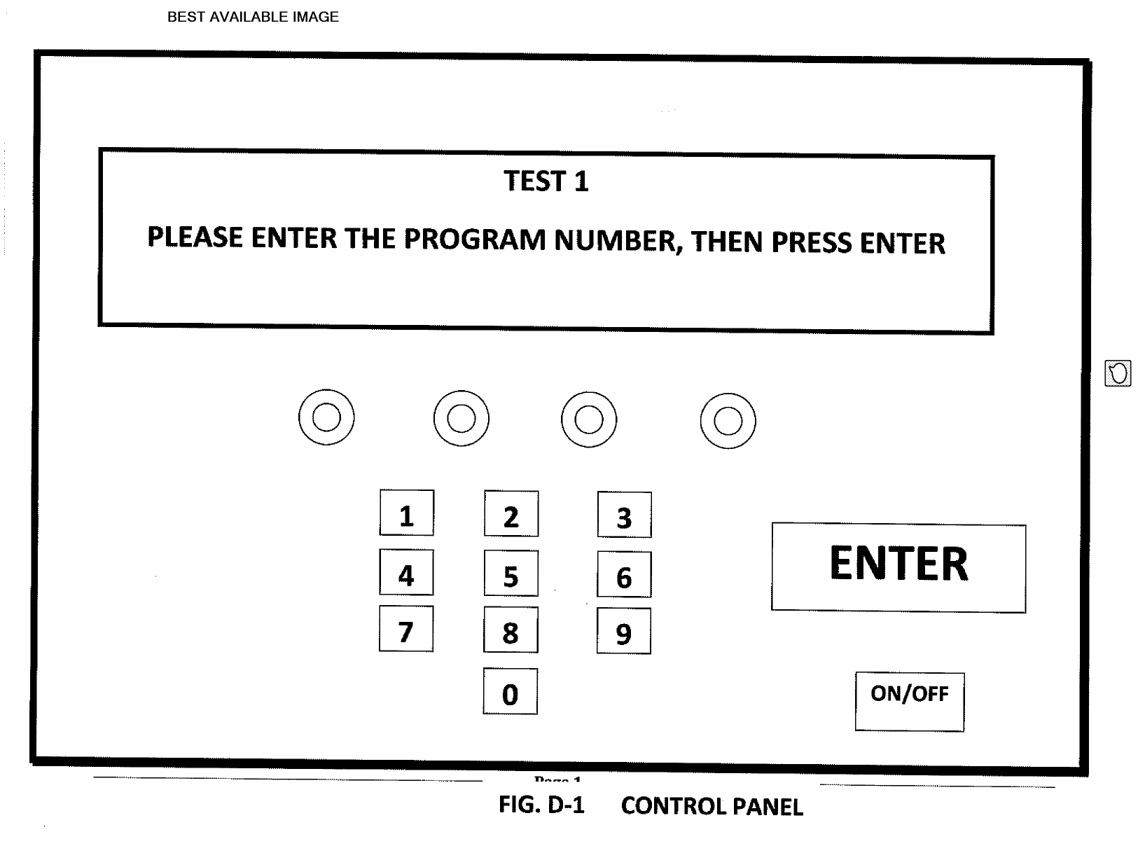

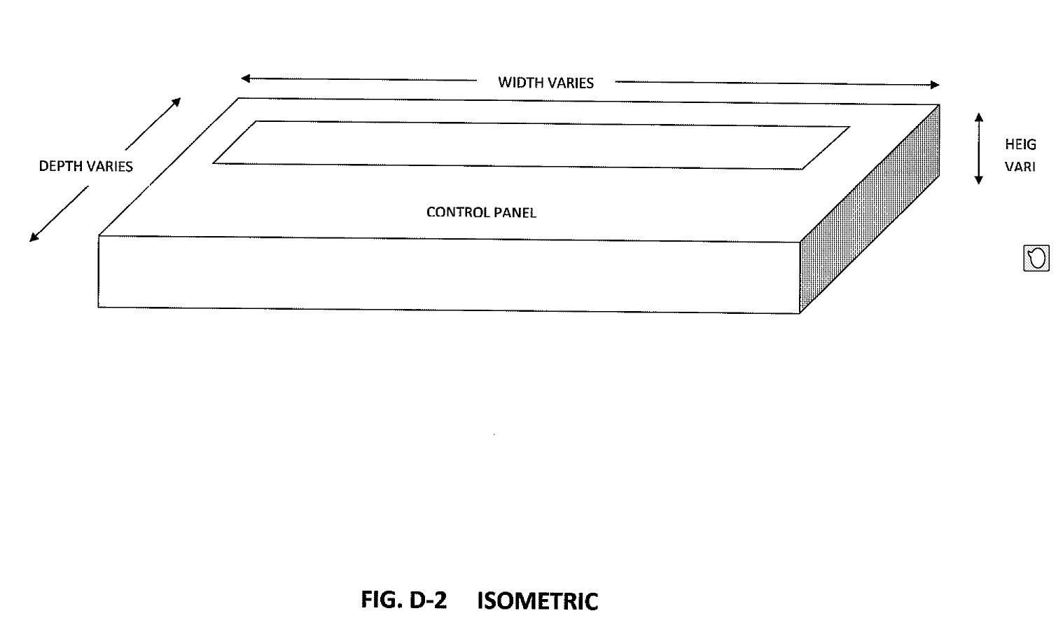

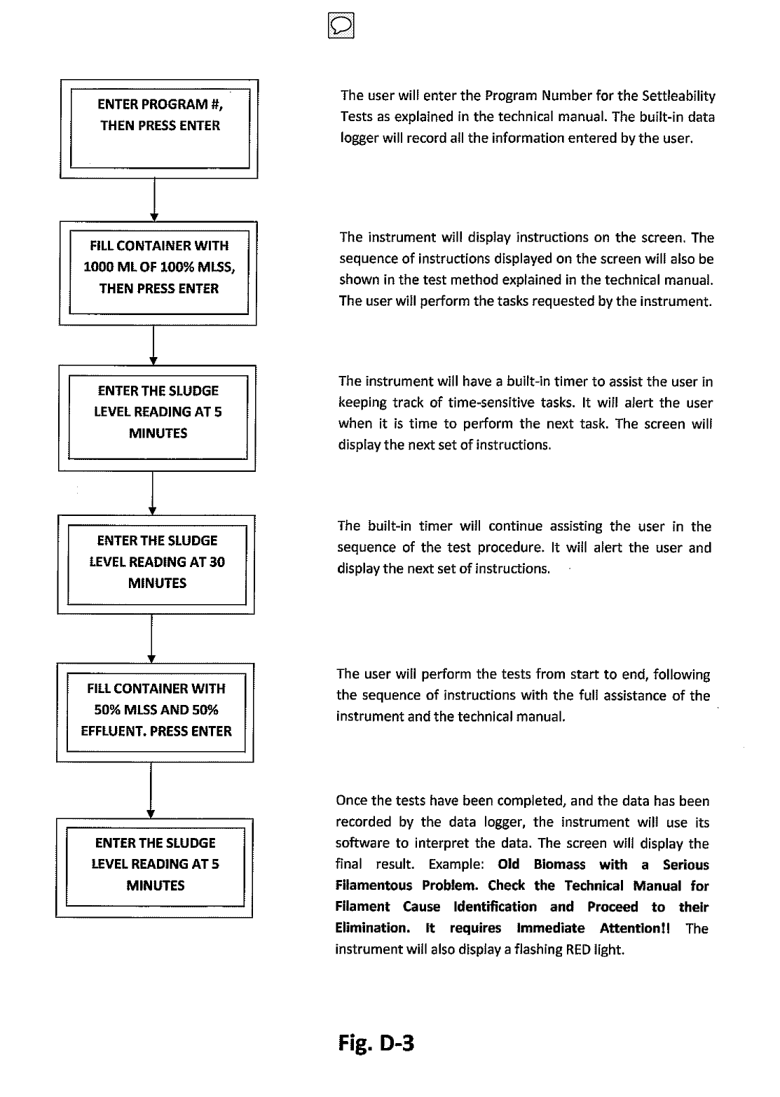

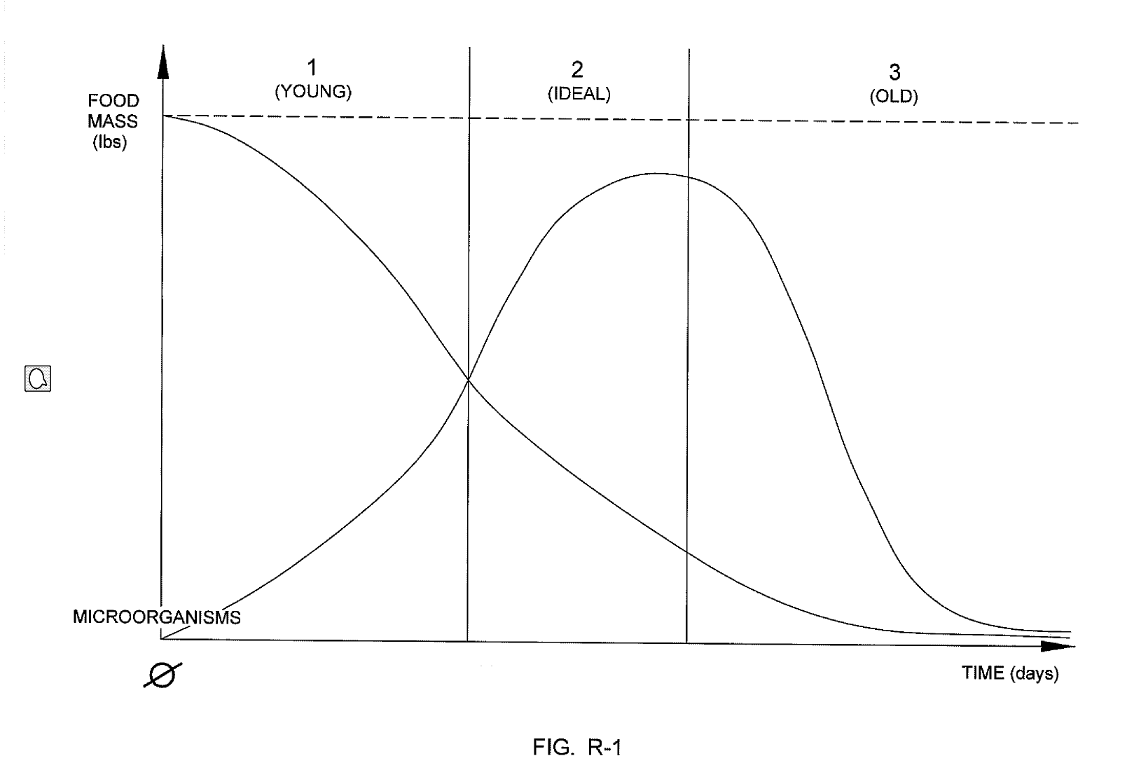

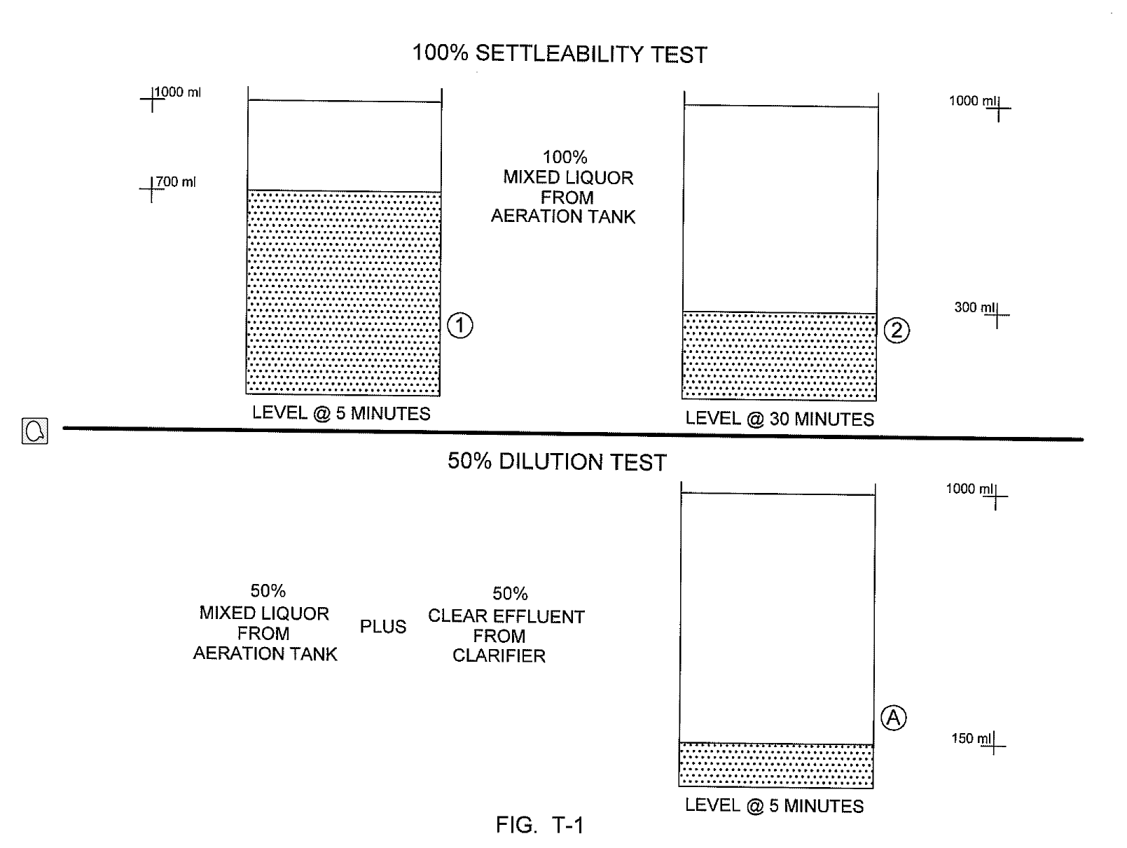

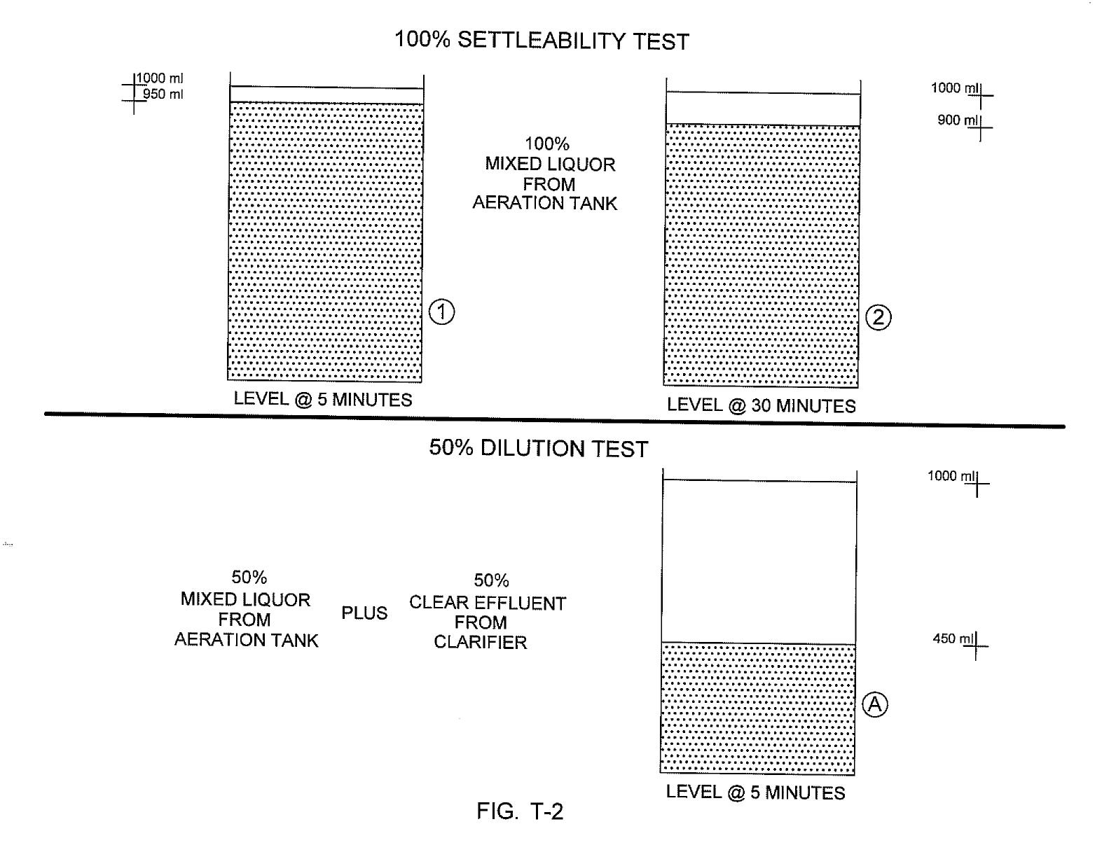

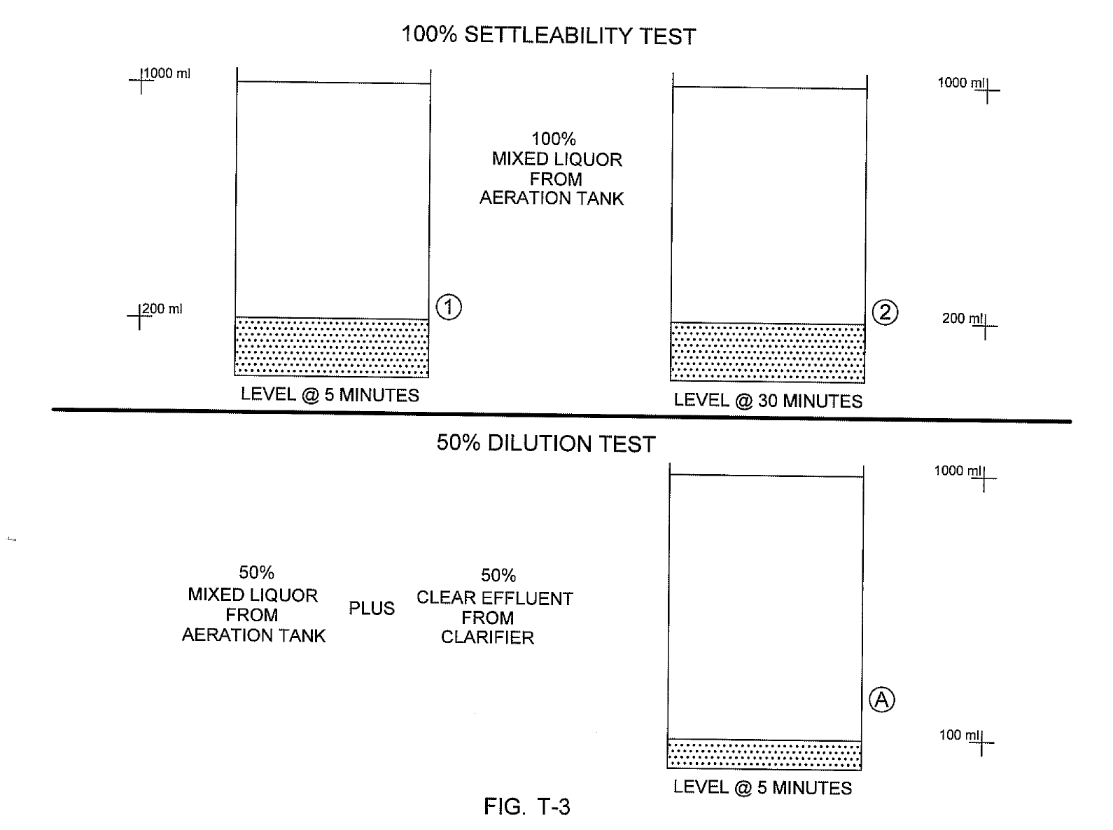

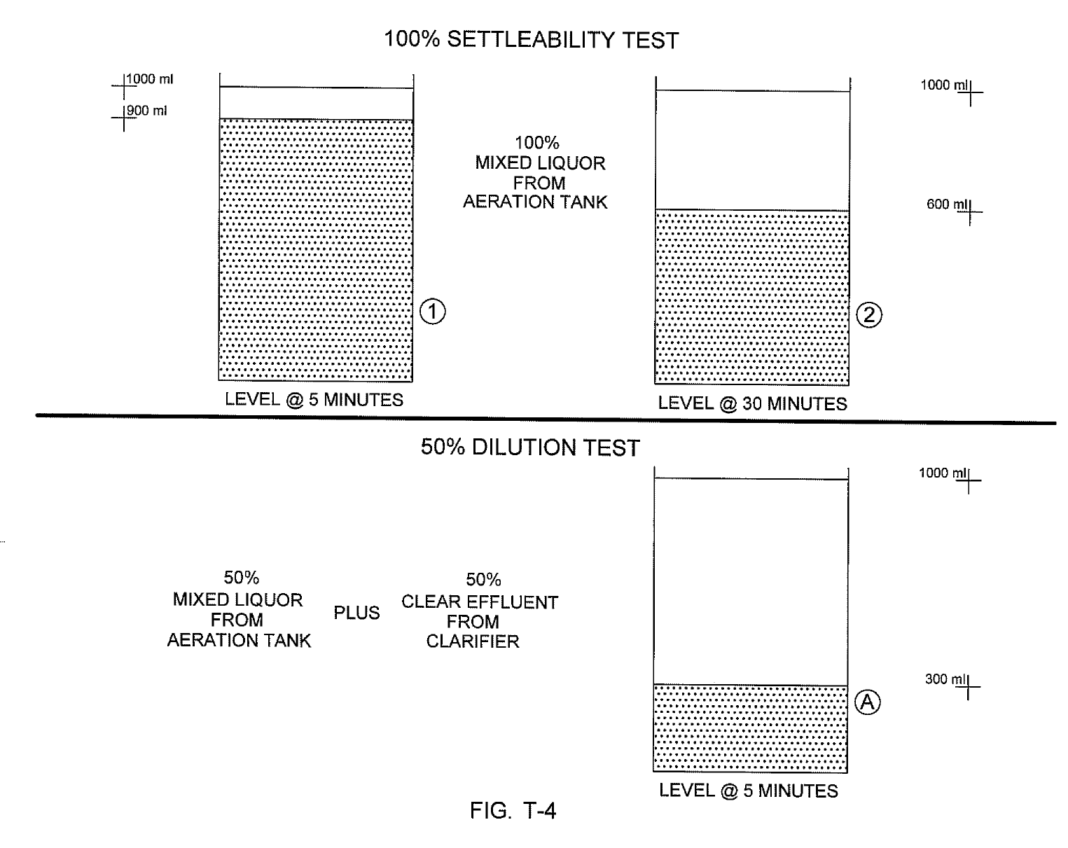

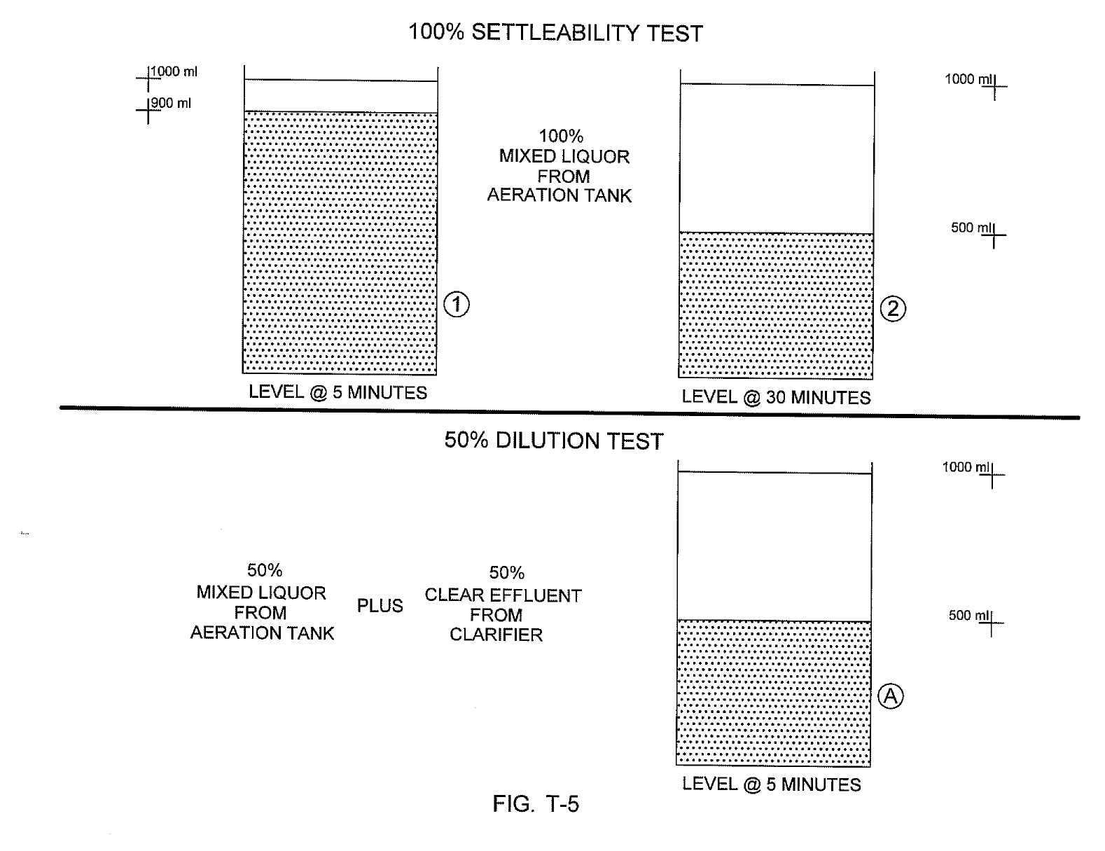

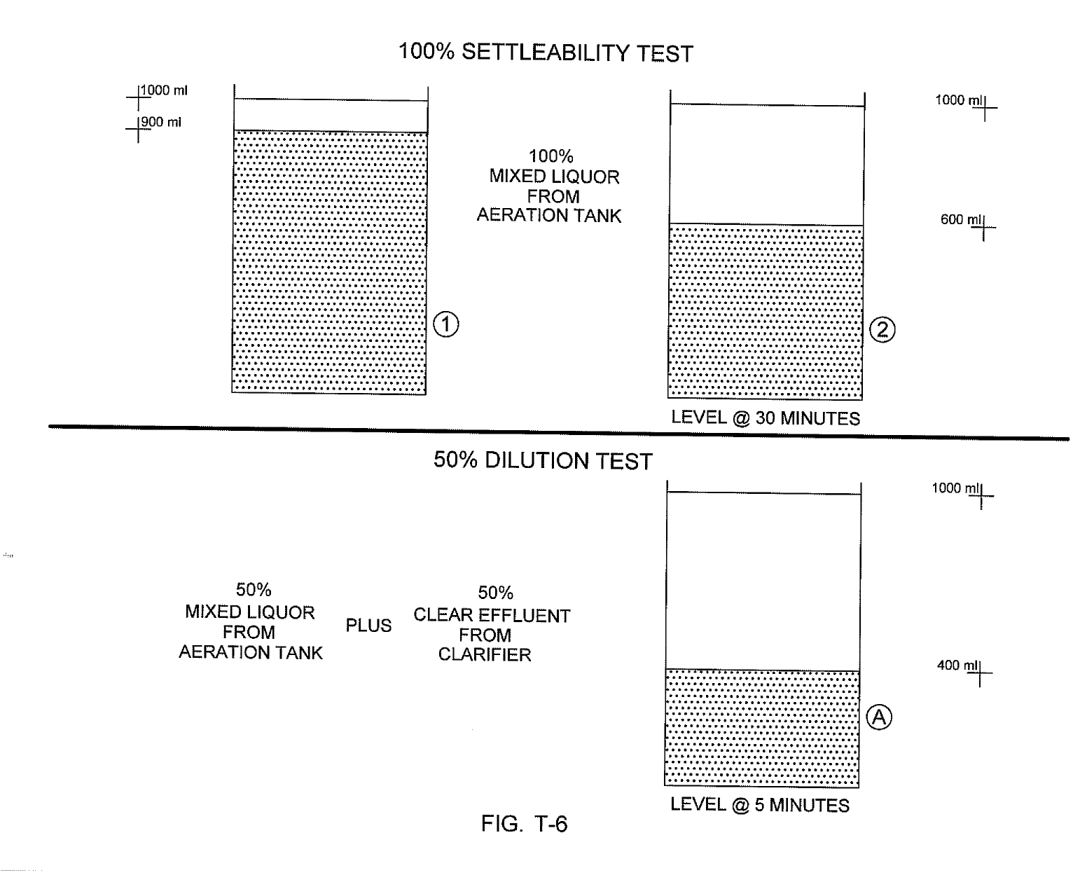

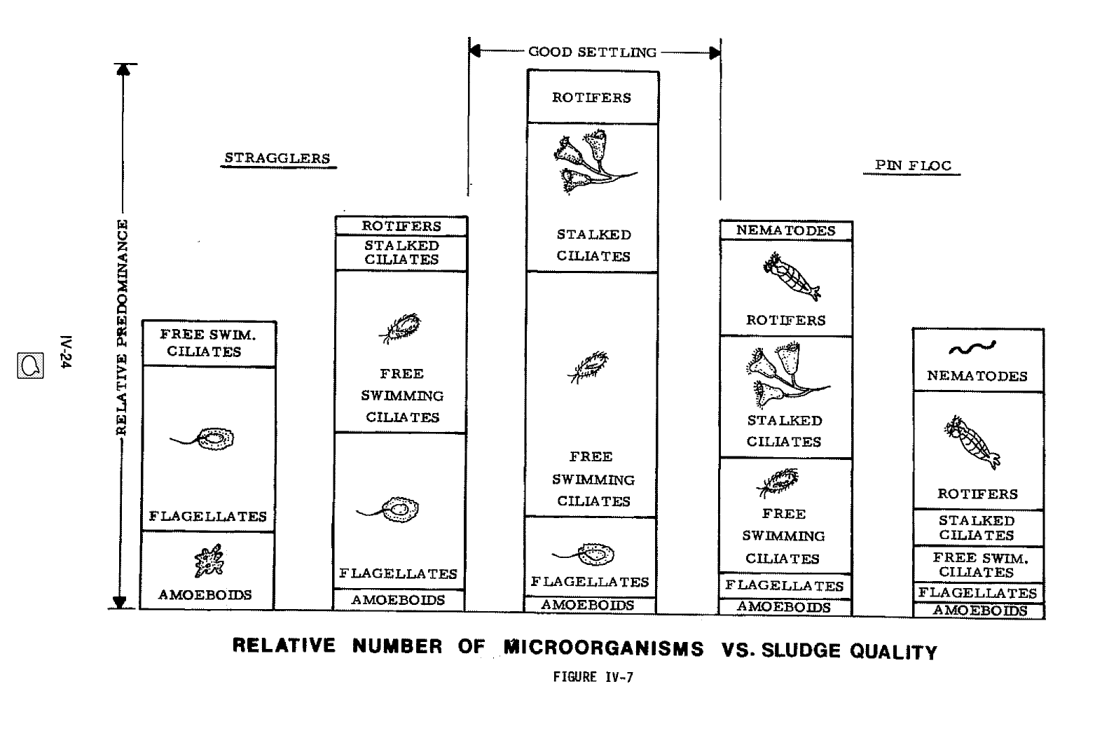

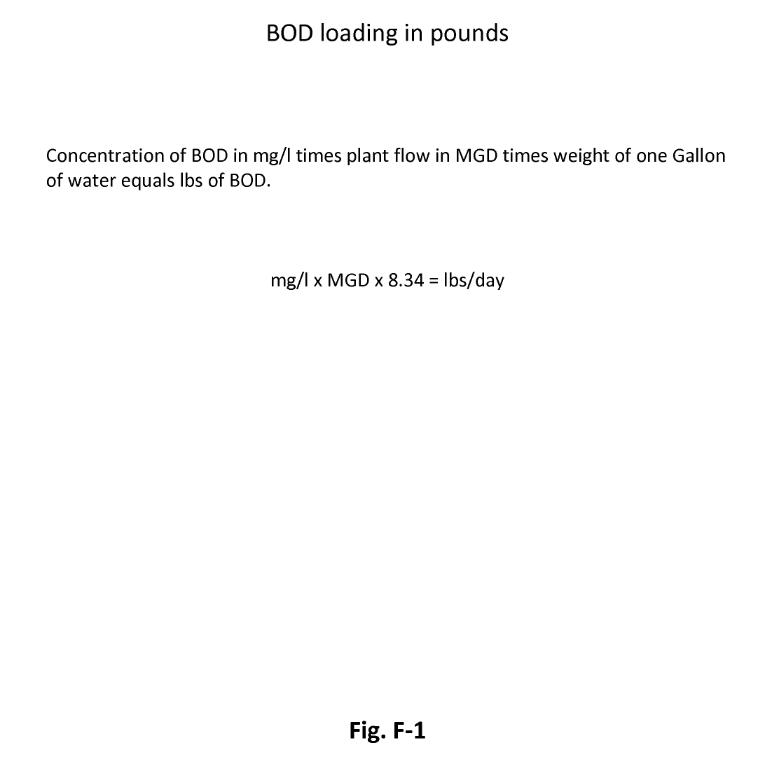

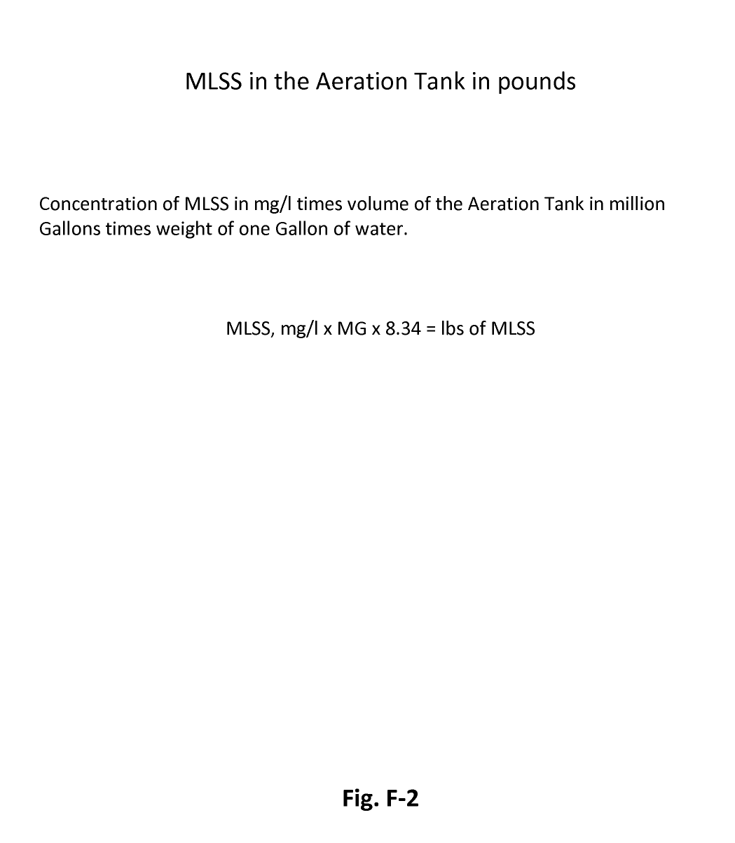

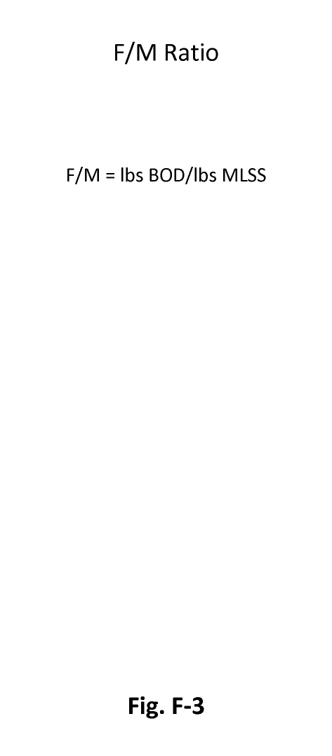

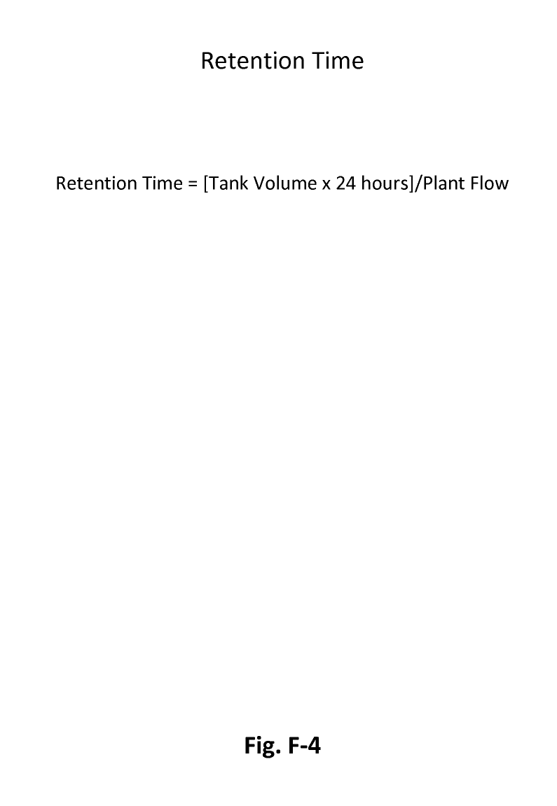

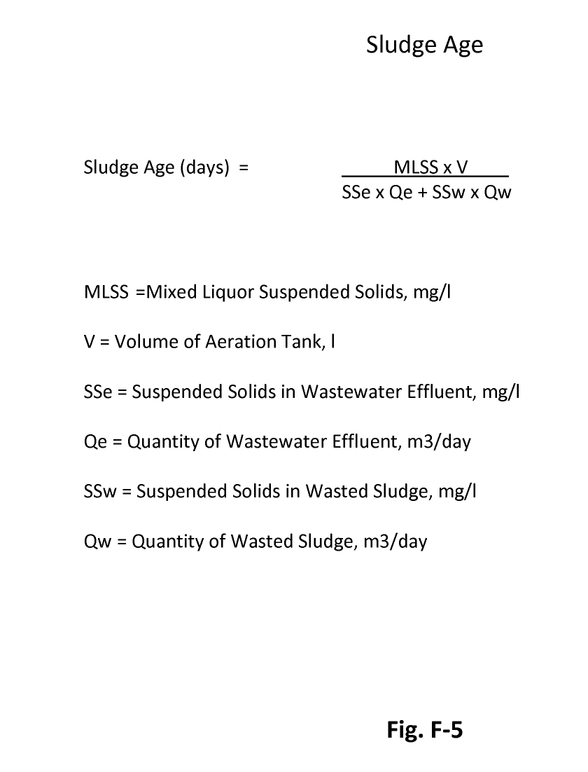

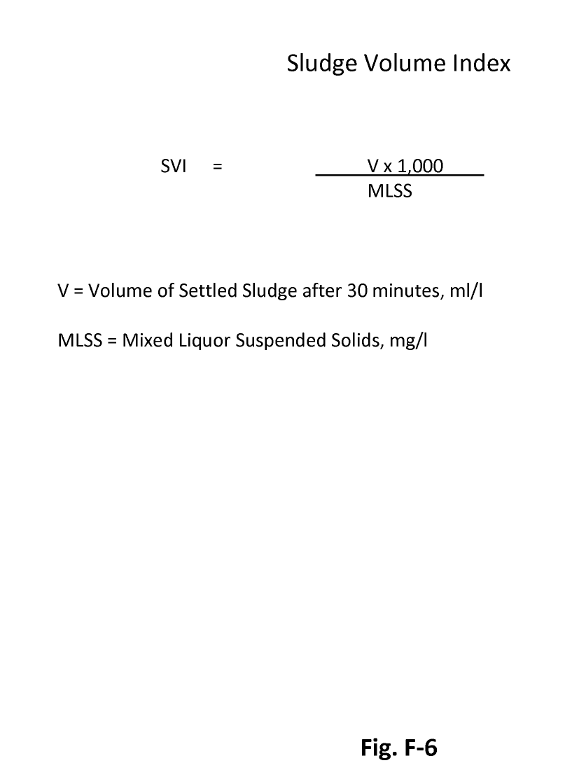

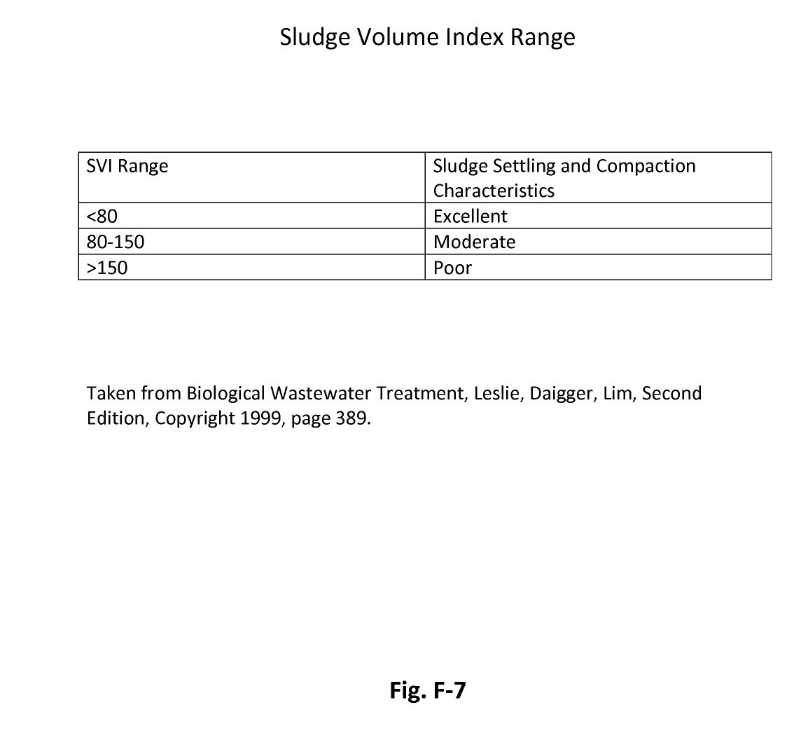

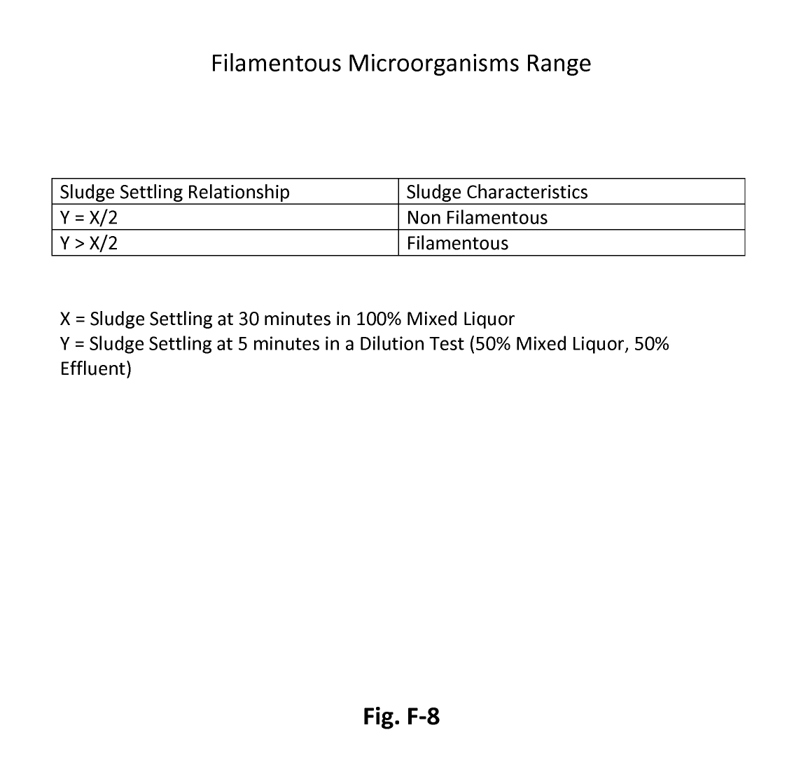

### CROSS REFERENCE TO RELATED APPLICATIONS

This non-provisional application is the continuation of the provisional patent application number: U.S. 61/542,172 filed on Jan. 10, 2011.

### FIELD OF THE INVENTION

The present invention applies specifically to the analysis of the health of the biomass contained in the basins of municipal and industrial wastewater treatment plants using activated sludge processes. It also applies to the prevention of biological problems concerning such biomass.

### BACKGROUND OF THE INVENTION

Municipal and industrial wastewater contains particulate and soluble organic matter. This matter represents the pollutants added to clean water during its use in various applications. In general, the pollutants are expressed as Biochemical Oxygen Demand (BOD).

One of the processes used to remove the pollutants from the wastewater is the Activated Sludge Process. Activated Sludge is a suspended-growth process. It consists of aerated basins (Aeration Tanks) containing Mixed Liquor Suspended Solids (MLSS) and wastewater.

The continuous air in the Activated Sludge Process is used to maintain an aerobic environment in which aerobic microorganisms can grow and reproduce, and to maintain these microorganisms in close contact with the pollutants (food matter) for their effective removal. The microorganisms convert the food into new growth (synthesis) and oxidize it into end products such as carbon dioxide, ammonia, and water. Through synthesis and oxidation food matter is fully stabilized.

Aeration is done using blowers and diffusers. Concentrated solids from the clarifier basin (Clarifier) where solids are separated from the liquid are returned to the Aeration Tanks as Return Activated Sludge (RAS) and the amount is controlled by manual or automatic devices.

The aerated basins (Aeration Tanks) continuously receive fresh wastewater which is the food source of the microorganisms.

The right amount of microorganisms (MLSS as per the plant design) and Dissolved Oxygen (2-3 mg/l) must be maintained in the Activated Sludge process to ensure that the pollutants present in the wastewater be effectively removed. Failure to maintain this biological balance (not enough or too many microorganisms) results in excess pollutants being released in the plant discharge (effluent) and into the receiving creek, river, lake, etc.

The right amount of aerobic microorganisms (MLSS) must also consist of strong, healthy microorganisms. A biomass consisting of microorganisms that are too young is not capable of removing all the pollutants. Any excess pollutants leave in the plant discharge (effluent).

While a biomass consisting of old microorganisms might temporarily produce a somewhat acceptable effluent, it will have suspended solids (pin floc) and the plant will be at risk due to its biological age (age of the microorganisms). Microorganisms at the end of their life cycle are no longer capable of efficiently removing all the pollutants as their activity level decreases with age, and are susceptible to a rapid death in the event of a toxic shock (excessive load of pollutants outside the plant design parameters) or to an eventual natural death. This reduction of microorganisms results in excess pollutants leaving in the discharge (effluent) causing similar pollution problems as a biomass with young microorganisms.

The solids accumulation in the aerated basins (Aeration Tanks) occurs due to the microbial metabolism. New cell growth occurs daily (growth rate) and it varies from plant to plant due to the waste being treated and to various factors particular to each plant such as: Mixed Liquor Suspended Solids (MLSS) concentration, temperature, pH, Food-to-Microorganism (F/M) ratio, etc.

Excess Mixed Liquor Suspended Solids (MLSS) must be removed (wasted) from the aerated basins (Aeration Tanks) to maintain the right (desirable) amount of microorganisms to match the desirable Food-to-Microorganism (F/M) ratio. The solids (sludge) removed from the Aeration Tank are called Waste Activated Sludge (WAS). Removal (wasting) of excess Mixed Liquor Suspended Solids (MLSS) is done using devices such as mechanical or pneumatic pumps. Excess Mixed Liquor Suspended Solids (MLSS) are wasted from the aerated basins (Aeration Tanks) into other aerated basins (Digester Tanks) for further stabilization (digestion) before their final disposal. Unlike the Aeration Tanks, the Digester Tanks are not fed with fresh wastewater.

After the pollutants have been removed (wastewater has been treated) in the aerated basins (Aeration Tanks), the solids must be separated from the liquid. The Mixed Liquor Suspended Solids (MLSS) travel from the Aeration Tanks into the Clarifier Tank where the solids separation occurs by gravity. For the solids to separate from the liquid, they must flocculate (form clumps). Flocculation occurs during the oxidation phase in the Aeration Tank and it is affected directly by the health/age of the microorganisms. The separated solids are then removed from the Clarifier as Return Activated Sludge (RAS) and the clear liquid is disinfected prior to its discharge (effluent).

### BRIEF SUMMARY OF THE INVENTION

The invention is a portable laboratory instrument that incorporates software designed to record laboratory tests results to determine the health/age of the biomass of a Wastewater Treatment Plant (WWTP) using an Activated Sludge Process. It produces an interpretation of the collected data, and delivers a final set of instructions to the Wastewater Treatment Plant (WWTP) operator. Its purpose is to prevent environmental disasters by detecting current/future biological problems.

### BRIEF DESCRIPTION OF THE SEVERAL VIEWS OF THE DRAWINGS

FIG. D-1 is a Plan View of the Control Panel of the invention (portable instrument).

FIG. D-2 is an isometric of the frame (structure) of the invention (portable instrument).

FIG. D-3 is a Flow Chart of the instructions (example) prompted by the invention (portable instrument) and displayed on its screen.

FIG. R-1 is a graphical representation of the life cycle of the biomass in an Activated Sludge process.

FIG. T-1 is a graphical representation of the 100% and 50% Settleability Tests for an Activated Sludge in healthy conditions.

FIG. T-2 is a graphical representation of the 100% and 50% Settleability Tests for an Activated Sludge that is too young.

FIG. T-3 is a graphical representation of the 100% and 50% Settleability Tests for an Activated Sludge that is too old.

FIG. T-4 is a graphical representation of the 100% and 50% Settleability Tests for an Activated Sludge that exceeds the ideal concentration but it does not have filamentous microorganisms.

FIG. T-5 is a graphical representation of the 100% and 50% Settleability Tests for an Activated Sludge that is extremely filamentous.

FIG. T-6 is a graphical representation of the 100% and 50% Settleability Tests for an Activated Sludge that started getting filamentous.

FIG. IV-7 is a graphical representation of the Relative Number of Microorganisms vs. Sludge Quality. This graph was taken from: EPA PROCESS CONTROL MANUAL FOR AEROBIC BIOLOGICAL WASTEWATER TREATMENT FACILITIES, MUNICIPAL OPERATIONS BRANCH. 1977.

FIG. F1-FIG. F-8 are formulas and comparison tables used in the field of wastewater treatment.

### DETAILED DESCRIPTION OF THE INVENTION

In order to efficiently and effectively treat the wastewater (remove the pollutants), the Wastewater Treatment Plant (WWTP) operator must have access to: knowledge and tools to monitor and control the treatment process.

Efficient and effective wastewater treatment requires maintaining the Activated Sludge healthy at all times. Monitoring the health of the Activated Sludge requires performing tests: Mixed Liquor Suspended Solids (MLSS), Microscopic Observation, Wastewater Temperature, pH, Dissolved Oxygen, Odor, Sludge Color, Sludge Blanket Level, Flow, Biochemical Oxygen Demand (BOD), Chemical Oxygen Demand (COD), Total Suspended Solids (TSS), Nitrogen (nitrate, nitrite, ammonia, total), Phosphorus, Air Temperature, Settleability Tests (at a concentration of: 100% and 50% Mixed Liquor Suspended Solids [MLSS]), Disinfection Readings (Chlorine or Ultraviolet Light), and calculating: Sludge Volume Index (SVI), Sludge Density Index (SDI), Food-to-Microorganism (F/M) Ratio, Sludge Age (SA) or Mean Cell Retention Time (MCRT). The Wastewater Treatment Plant (WWTP) operations/discharge permit might require even more laboratory tests to comply with local, state, and federal regulations. Once all these data have been collected, the Wastewater Treatment Plant (WWTP) operator must interpret the results to determine the health of the Activated Sludge, and detect any biological problems.

Over the years a lot of literature has been written concerning the design of Wastewater Treatment Plants (WWTP's) but not as much has been done concerning the operation of such facilities. Wastewater Treatment Plant (WWTP) designs are done under the assumption that the plant will run at 100% design conditions: 100% Design Flow, and 100% Design Organic Load (pollutants). However, in real life, the operator routinely encounters that the actual conditions vary from those set in the design parameters (Engineering Calculation Sheets). For example, an actual wastewater flow that is only 50% of the Design Flow will have a retention time twice as long as the one in the Wastewater Treatment Plant (WWTP) design, whereas an actual flow that is 200% the Design Flow will only have half the design retention time. Either extreme actual condition has a direct impact on the Activated Sludge age and health, resulting in biological problems, and poor quality effluent.

While mentioned in wastewater treatment literature, the immediate/direct impact of the actual age of the microorganisms in the treatment process is neither studied in the depth it deserves nor with the approach to understand its effect on a Wastewater Treatment Plant (WWTP) that is outside the Design Parameters (Design Flow, Design Organic Load). The Actual Biological Age of a Wastewater Treatment Plant (WWTP) is as important as the age of a human being (patient) in order to administer the proper medical treatment. Being able to determine the Actual Biological Age of a Wastewater Treatment Plant (WWTP) is crucial to determine the right course of action for process control. Adjusting the process of a young Wastewater Treatment Plant (WWTP) is different from adjusting the process of an old Wastewater Treatment Plant (WWTP), just as the medical treatment varies from a young to an old patient.

In the event of experiencing poor quality effluent (environmental permit violation), the operator is under pressure to immediately bring the Wastewater Treatment Plant (WWTP) into compliance to prevent an environmental disaster downstream. It is under this pressure that the operator must perform all the tests mentioned above to determine the cause of the problem. If for an experienced operator this situation can be overwhelming, for an operator lacking the knowledge, tools, and/or experience, it is much worse and can have catastrophic results.

A lot of the literature available to Wastewater Treatment Plant (WWTP) operators focuses on troubleshooting (reaction) to correct different conditions (biological problems). Under stressful conditions and with little time, the operator must use this information, and perform all the laboratory tests, to immediately try to correct the problems leaving little room for an in-depth analysis of the cause of the biological problem itself. If the cause of the problem is not eliminated, the problem will reoccur.

The invention (portable instrument) can detect biological problems for their immediate attention/correction; and most importantly: the invention can prevent them, weeks/months before they happen. By detecting a negative behavior of the biomass, the invention can alert the operator of a biological problem weeks/months before it causes a crisis. Example: filamentous microorganisms grow very slowly without being noticed by an inexperienced operator until they cause major biological problems.

Following a sequence of instructions displayed on the screen of the invention (portable instrument), the invention is calibrated using data specific to the Wastewater Treatment Plant (WWTP) being analyzed. Following the prompts of the invention (displayed on the screen and explained in the technical manual), the operator inputs Design Parameters (Design Flow, Design Organic Load), and Actual Values (Actual Flow, Actual Organic Load). Then, in the same sequence of data collection, the operator will be prompted (as illustrated in FIG. D-3) to input Actual Values on Operational Parameters: Actual Settleability Tests (at a concentration of: 100% and 50% Mixed Liquor Suspended Solids [MLSS]), Actual pH, Actual Wastewater Temperature, Actual Mixed Liquor Suspended Solids (MLSS), and Influent BOD (raw wastewater).

The invention (portable instrument) will then take the actual data and using its internal software (algorithms), will perform the calculations for the process control parameters necessary to determine the age/health of the Wastewater Treatment Plant (WWTP). The screen will display the results (as illustrated in FIG. D-3), prompting the operator to take the proper actions as per the results obtained. The overall health/condition of the Wastewater Treatment Plant (WWTP) will also be displayed with a light that depending on its health/condition will vary in color. Green=Good, Yellow=Caution, Orange=Warning, Red=Bad.

The invention's software will include formulas that are universally used in the field of wastewater treatment. These formulas include, but are not limited, to: Food-to-Microorganism (F/M) Ratio, Hydraulic retention Time, Sludge Age, Settleability Test at 100% Mixed Liquor Suspended Solids (MLSS) concentration, Settleability Test at 50% Mixed Liquor Solids Suspended (MLSS) concentration, Hydraulic Wastewater Treatment Plant (WWTP) Usage vs. Design Capacity, Organic Wastewater Treatment Plant (WWTP) Usage vs. Design Capacity, Sludge Value Index (SVI), Nutrient Removal Efficiency, etc. The software will also include the acceptable ranges for the operational parameters required to determine the age/health of the biomass. The values entered by the user will be used to calculate the operational parameters, and will then be compared to the normal values for the: Young, Ideal and Old Phases (with and without filamentous problems). The software will then produce the final interpretation and deliver the results on the screen of the instrument along with the proper specific instructions to correct the situation. The final result will also display the light in the proper color (green, yellow, orange or red).

The simplicity of the invention's step-by-step instructions, easy-to-understand results, and the universally recognized meaning of the light colors (Green=Good, Yellow=Caution, Orange=Warning, Red=Bad) will allow any user (even if they lack training in the field of wastewater treatment) to quickly understand the overall health/condition of a Wastewater Treatment Plant (WWTP) without requiring to read, understand and interpret numerous pages of data. It will allow any user to quickly react to any situation and seek outside help if necessary. By reducing the response time and by preventing biological problems, the municipally/industry will save money in troubleshooting-related costs. Most importantly: they will prevent environmental disasters.

### DETAILED DESCRIPTION OF THE DRAWINGS

FIG. D-1 is a Plan View of the Control Panel of the invention (portable instrument). It shows: a view of the screen displaying instructions to be followed by the user, four (4) lights (green, yellow, orange, and red) below the screen, numerical keys (0-9), the “enter” key, and the “power” key. The prompts displayed on the screen will guide the user to perform all the necessary tests and input the results from start to end. Once all the data has been entered, the instrument will perform the interpretation of the values entered, and it will deliver the final result. If the result is within the good range (proper biological age), the green light will turn on. If the result is slightly outside the good range (towards young or old biological age), the yellow light will turn on, and the screen will provide a caution message with instructions to be followed by the user. If the result is moving rapidly away from the good range (heading rapidly towards young or old biological age), the orange light will turn on, and the screen will display a warning along with instructions to be followed by the user. If the result is bad, the red light will turn on, and the screen will display an emergency alert along with instructions to be followed by the user to immediately proceed to correct the situation. If the instrument detects an emergency situation that requires immediate attention, it will freeze itself displaying the emergency situation instructions. The instrument will have to be unlocked by the user's supervisor (WWTP supervisor, superintendent, manager, mayor, etc.) using a numerical code provided by the manufacturer. In order to continue using the instrument, all critical situations will have to be acknowledged by the user's supervisor. The instrument's internal data logger will record all the values entered: date, time, user name, tests results, final interpretation, etc. The data can then be transferred from the instrument's data logger into a computer system for storage, printing, sharing, etc.

FIG. D-2 is an isometric of the frame (structure) of the invention (portable instrument). It shows a view of the basic frame of the instrument. Its dimensions are unrestricted and can vary.

FIG. D-3 is a Flow Chart of the instructions (example) prompted by the invention (portable instrument) and displayed on its screen. It shows an example of the step-by-step sequence of instructions that the instrument will display on the screen so the user can perform the tests, and input the results. These steps will also be provided in the technical manual.

FIG. R-1 is a graphical representation of the life cycle of the biomass in an Activated Sludge process. It shows the growth curve of the microorganisms as they reproduce, mature and die. It also shows the food (pollutants) curve as it decreases due to microbial activity. The time line shows the three main phases of the life cycle: (1) Young Phase; (2) Ideal Phase; and (3) Old Phase. On Phase (1) the amount of food (pollutants) is greater than the amount of microorganisms, thus the effluent will contain pollutants. On Phase (2) the number of microorganisms is greater than the amount of food, thus the effluent will not contain any pollutants. On Phase (3) the number of microorganisms is in decline due to age/health, thus the biomass is at risk of dying prematurely. While it may produce somewhat acceptable effluent quality, it is at risk in the event of a toxic shock or natural death.

FIG. T-1 is a graphical representation of the 100% and 50% Settleability Tests for an Activated Sludge in healthy conditions. It shows the proper settling level of the Mixed Liquor Suspended Solids (MLSS) at 5 and 30 minutes when the biomass has the right age/health. The reading of the 50% Dilution Test confirms that there are no filamentous microorganisms. These readings are typical of Phase 2 of FIG. R-1.

FIG. T-2 is a graphical representation of the 100% and 50% Settleability Tests for an Activated Sludge that is too young. It shows the non desirable settling level of the Mixed Liquor Suspended Solids (MLSS) at 5 and 30 minutes when the biomass is too young. The reading of the 50% Dilution Test confirms that there are no filamentous microorganisms. These readings are typical of Phase 1 of FIG. R-1.

FIG. T-3 is a graphical representation of the 100% and 50% Settleability Tests for an Activated Sludge that is too old. It shows the non desirable settling level of the Mixed Liquor Suspended Solids (MLSS) at 5 and 30 minutes when the biomass is too old. The reading of the 50% Dilution Test confirms that there are no filamentous microorganisms. These readings are typical of Phase 3 of FIG. R-1.

FIG. T-4 is a graphical representation of the 100% and 50% Settleability Tests for an Activated Sludge that exceeds the ideal concentration. It shows the non desirable settling level of the Mixed Liquor Suspended Solids (MLSS) at 5 and 30 minutes when the biomass is leaving the right age/health range. The reading of the 50% Dilution Test confirms that there are no filamentous microorganisms. These readings are typical of Phase 2 moving towards Phase 3 of FIG. R-1.

FIG. T-5 is a graphical representation of the 100% and 50% Settleability Tests for an Activated Sludge that is extremely filamentous. It shows the non desirable settling level of the Mixed Liquor Suspended Solids (MLSS) at 5 and 30 minutes when the biomass is experiencing major health problems. The reading of the 50% Dilution Test confirms that there are too many filamentous microorganisms. These readings are typical of: (1) an extreme case of Phase 3 of FIG. R-1, or (2) the presence of an excessive amount of pollutants that encourage the growth of filamentous microorganisms.

FIG. T-6 is a graphical representation of the 100% and 50% Settleability Tests for an Activated Sludge that started getting filamentous. It shows the non desirable settling level of the Mixed Liquor Suspended Solids (MLSS) at 5 and 30 minutes when the biomass has begun experiencing health problems. The reading of the 50% Dilution Test confirms that there are filamentous microorganisms reproducing. These readings are typical of: (1) Phase 3 of FIG. R-1 and getting worse, or (2) the presence of an excessive amount of pollutants that encourage the growth of filamentous microorganisms but that it has been detected before causing a biological crisis.

FIG. IV-7 is a graphical representation of the Relative Number of Microorganisms vs. Sludge Quality. This graph was taken from: EPA PROCESS CONTROL MANUAL FOR AEROBIC BIOLOGICAL WASTEWATER TREATMENT FACILITIES, MUNICIPAL OPERATIONS BRANCH. 1977. This graph shows the predominant microorganisms during the different phases of the life cycle of the biomass. The microorganisms in the “STRAGGLERS” section are typical of the Young Phase (See FIG. R-1), the microorganisms in the “GOOD SETTLING” section are typical of the Ideal Phase (See FIG. R-1), and the microorganisms in the “PIN FLOC” section are typical of the Old Phase (See FIG. R-1).

FIG. F1-FIG. F-8 are formulas and comparison tables used in the field of wastewater treatment.

### DEFINITION OF TERMS

Activated Sludge—Biological floc developed from a mix of raw wastewater, air, and microorganisms which reduces the organic content of the raw wastewater.

Activated Sludge Process—A process for treating municipal and industrial wastewater using air and biological floc (sludge or biomass) composed of bacteria and protozoa.

Aeration Tank—A fluid-holding basin with air diffusers to aerate its contents by bubbling air through the liquid.

Aerobic—Living or occurring only in the presence of oxygen.

Aerobic Bacteria—Bacteria which require oxygen in order to grow and survive.

Bacteria—Bacteria are a major group of living organisms. They are microscopic and essentially unicellular, with a relatively simple cell structure.

Biochemical Oxygen Demand—An indicator for the concentration of biodegradable organic matter present in a sample of water. It can be used to infer the general quality of the water and its degree of pollution.

Biomass—The mass of living organisms within a particular environment.

Bulking—A condition when the sludge is not settling properly. This may be caused by filamentous microorganisms, which branch out, preventing the sludge from compacting properly.

Clarifier—An engineered basin where the solids settle and the clear liquid leaves as effluent.

Chemical Oxygen Demand—The standard method for indirect measurement of the amount of pollution (that cannot be oxidized biologically) in a sample of water.

Denitrification—The removal of nitrogen or nitrogen groups from a compound.

Diffuser—An air distribution outlet for discharging air in various directions and planes.

Digester—A basin in which sludge is placed to permit digestion to occur.

Digestion—A process in which the organic matter in sludge is decomposed by bacteria and carried out in the Digester Tank.

Dissolved Oxygen—The amount of oxygen dissolved in water or wastewater as an indication of the degree of health of the water.

Effluent—Wastewater (or other liquid) partially or completely treated, flowing out of a treatment plant.

Endogenous—Produced or growing from within. This term usually implies a phase in which cell death occurs.

Filaments—Unicellular microorganisms that branch out and form radiating colonies.

Floc—A flocculent mass that forms in a liquid as a result of precipitation or aggregation of suspended particles.

Flocculation—The process in which particles from flocculent masses as a cloud or chemical precipitate.

Food-to-Microorganism (F/M) Ratio—It indicates the organic load into the activated sludge system and is expressed in lbs of BOD per lb of MLSS per day.

Fungi—Single-celled or multicellular organisms without chlorophyll that reproduces by spores and lives by absorbing nutrients from organic matter.

Influent—The fluid entering a system, process, tank, etc.

Mean Cell Residence Time (MCRT)—The average time that bacteria or sludge (MLSS) stay in the aeration tank usually expressed in days.

Metabolism—The series of processes by which food is converted into the energy and products needed to sustain life.

Microorganism—A microorganism or microbe is an organism that it is so small that it is microscopic (invisible to the naked eye) as bacteria, protozoa, and some fungi and algae.

Mixed Liquor—A mixture of activated sludge and water containing organic matter undergoing activated sludge treatment in an aeration tank.

Mixed Liquor Suspended Solids (MLSS)—The concentration of Suspended Solids in Mixed Liquor carried in the aeration tank of an Activated Sludge Treatment Plant.

Mixed Liquor Volatile Suspended Solids (MLVSS)—The microbiological suspension in the aeration tank of an Activated Sludge Wastewater Treatment Plant.

Nitrification—The biological oxidation of ammonia with oxygen into nitrite followed with the oxidation of these nitrites into nitrates.

Organic Matter—Substances of (dead) plant or animal matter, with a carbon-hydrogen structure.

Oxidation—A chemical reaction in which oxygen is added to an element or compound.

Pollutant—A substance that causes pollution, especially a waste material that contaminates air, soil, or water.

Protozoa—Single-celled organisms with nuclei that show some characteristics usually associated with animals, most notably mobility and heterotrophy (cannot synthesize its own food).

Return Activated Sludge (RAS)—Activated Sludge that is returned to the aeration tank of an Activated Sludge process to assist with treatment of wastewater.

Settling—The gravity separation of heavy from light materials. Example: the settling out of dense solids from a liquid carrier.

Sludge—The solids in wastewater that separate during treatment.

Sludge Age—The mean residence time of microorganisms in the system. While the hydraulic retention time may be in hours, the mean cell residence time may be in days.

Sludge Volume Index—An indication of the sludge settleability in the clarifier. It indicates changes in the sludge settling characteristics and quality.

Suspended Solids—Small solid particles which remain in suspension in water as a colloid or due to the motion of the water. It is used as one indicator of water quality.

Wastewater—Water that has been used for washing, flushing, or in a manufacturing process.

All the words in the claims are intended to be used in the normal, customary usage of grammar, the trade and the English language.

### BIBLIOGRAPHY

Standard Methods for the Examination of Water and Wastewater

American Public Health Association

American Water Works Association

Water Environment Federation 19^{th} Edition Copyright 1995

PROCESS CONTROL MANUAL FOR AEROBIC BIOLOGICAL WASTEWATER

TREATMENT FACILITIES

ENVIRONMENTAL PROTECTION AGENCY

MUNICIPAL OPERATIONS BRANCH

OFFICE OF WATER PROGRAM OPERATIONS

WASHINGTON, D.C.

MARCH 1977

WASTEWATER MICROBIOLOGY

GABRIEL BITTON

Second Edition Copyright 1999

Brock Biology of Microorganisms

Michael T. Madigan

John M. Martinko

Jack Parker

Ninth Edition Copyright 2000

BIOLOGICAL WASTEWATER TREATMENT

C. P. LESLIE GRADY, JR.

GLEN T. DAIGGER

HENRY C. LIM

SECOND EDITION, REVISED AND EXPANDED

Copyright 1999

INTRODUCTION TO ENVIRONMENTAL MICROBIOLOGY

RALPH MITCHELL

Copyright 1974

Biology and Water Pollution Control

CHARLES E. WARREN

Copyright 1971

Get more out of your wastewater treatment plant—complexity made simple

Pernille Ingildsen

Gustaf Olsson

Copyright 2001

NUTRIENT CONTROL

Manual of Practice FD-7

Facilities Design

Water Pollution Control Federation 1983

Safety and Health in Wastewater Systems

Manual of Practice SM-1

Water Environment Federation

Copyright 1994

1. The invention is a system of software technology contained in a portable frame capable of receiving values (entered by the user) of laboratory tests performed on the biomass of a Wastewater Treatment Plant (WWTP).

2. The system can determine the age range (young, ideal or old) of the biomass of a Wastewater Treatment Plant (WWTP).

3. The system can determine the health of the biomass (using filamentous microorganisms as the indicator microorganism) of a Wastewater Treatment Plant (WWTP).

4. The system can produce an interpretation of the health/age of the biomass of a Wastewater Treatment Plant (WWTP).

5. The system can generate instructions to correct and/or prevent biological problems at a Wastewater Treatment Plant (WWTP).
